(19) United States
(12) Patent Application Publication
(10) Pub. No.: US 2025/0272210 A1
(43) Pub. Date: Aug. 28, 2025

(54) LOG EXTRACTION METHOD AND LOG EXTRACTION SYSTEM

(71) Applicant: Hitachi, Ltd., Tokyo (JP)

(72) Inventors: Hitoshi YABUSAKI, Tokyo (JP); Takaya IDE, Tokyo (JP); Darshan CHAWDA, Tokyo (JP)

(73) Assignee: Hitachi, Ltd., Tokyo (JP)

(21) Appl. No.: 18/884,953

(22) Filed: Sep. 13, 2024

(30) Foreign Application Priority Data
Feb. 28, 2024 (JP) 2024-028871

(51) Int. Cl. G06F 11/30; H04L 9/06

(52) U.S. Cl. CPC G06F 11/3082; H04L 9/0643

(57) ABSTRACT

In a log extraction method, logs relating to requests of the same type are grasped and a same type request related identifier list for managing a correspondence relation between identifier keys for identifying identifiers included in the logs and identifier values representing values that the identifiers take in the logs is generated. In the log extraction method, correlation degrees of the identifier values among the requests of different types are calculated based on the identifier values of the same identifiers associated with the requests of the different types in the same type request related identifier list. In the log extraction method, the identifier keys are set as nodes, a relation between the identifier keys and the identifiers is set as a link, and the correlation degrees are set as link metrics and a related identifier graph obtained by grouping the identifier keys based on the link metrics is generated.

### INCORPORATION BY REFERENCE

This application claims priority based on Japanese patent application, No. 2024-28871 filed on Feb. 28, 2024, the entire contents of which are incorporated herein by reference.

### BACKGROUND

The present invention relates to a log extraction method and a log extraction system.

In an information processing system that executes microservices (subsystems) in a plurality of containers, logs involved in the execution of the microservices for each of the containers are enormously output. For example, when a failure cause in the information processing system is specified or a user affected by a failure is specified, enormous logs for a plurality of microservices are analyzed. In analyzing the enormous logs, it is unrealistic to cover patterns of combinations of all the logs. Thus, in order to narrow down target logs in advance to efficiently perform a log analysis, a technique for extracting, based on identifiers and context attributes, logs having a high relationship has been disclosed (see, for example, U.S. Pat. No. 11,354,301 (Patent Literature 1)).

However, the related art explained above is based on the premise that names of the identifiers and the context attributes are known and fixed and values of the identifiers and the context attributes coincide. For this reason, when logs are various as in an information processing system constructed by combining open software and existing applications, there is a problem in that names and values of identifiers are different and it is difficult to associate related identifiers. If the association of the identifiers is inappropriate, for example, logs having high correlation cannot be extracted.

The present invention has been devised considering the above circumstances, and an object of the present invention is to more appropriately associate identifiers of various logs.

### SUMMARY

In an aspect of the present invention, there is provided a log extraction method executed by a log extraction system that extracts logs output from an information processing system including a plurality of subsystems, the log extraction system including a processor and a storage unit, the storage unit including: an event log storing unit configured to store event logs relating to events generated in the information processing system according to requests to the information processing system; a log storing unit configured to store the logs output from the plurality of subsystems in response to the events; and a system configuration information storage unit configured to store system configuration information for managing a correspondence relation between information capable of identifying types of the requests and information capable of identifying the subsystems, the log extraction method including processing for the processor to: grasp the logs relating to the requests of a same type based on the system configuration information and the event logs; generate, based on the logs relating to the requests of the same type, a same type request related identifier list for managing a correspondence relation between identifier keys for identifying identifiers used in the information processing system included in the logs and identifier values representing values that the identifiers take in the logs; calculate correlation degrees of the identifier values among the requests of different types based on the identifier values of the same identifiers associated with the requests of the different types in the same type request related identifier list; and set the identifier keys as nodes, set a relation between the identifier keys and the identifiers as a link, and set the correlation degrees as link metrics and generate a related identifier graph obtained by grouping the identifier keys based on the link metrics.

According to the present invention, it is possible to more appropriately associate identifiers of various logs.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a diagram illustrating a configuration of an overall system including a log extraction system according to a first embodiment;

FIG. 2 is a diagram illustrating a configuration of system configuration information according to the first embodiment;

FIG. 3 is a flowchart illustrating related identifier extraction processing according to the first embodiment;

FIG. 4 is a diagram illustrating a configuration of a same type request related identifier list according to the first embodiment;

FIG. 5 is a diagram for explaining a method of calculating a correlation degree between different type requests according to the first embodiment;

FIG. 6 is a diagram illustrating a configuration of a related identifier graph according to the first embodiment;

FIG. 7 is a diagram illustrating a configuration of an overall system including a log extraction system according to a second embodiment;

FIG. 8 is a flowchart illustrating related identifier extraction processing according to the second embodiment;

FIG. 9 is a diagram for explaining extraction processing for identifier keys and identifier values relating to identifiers according to the second embodiment; and

FIG. 10 is a diagram illustrating a configuration of hardware of a computer.

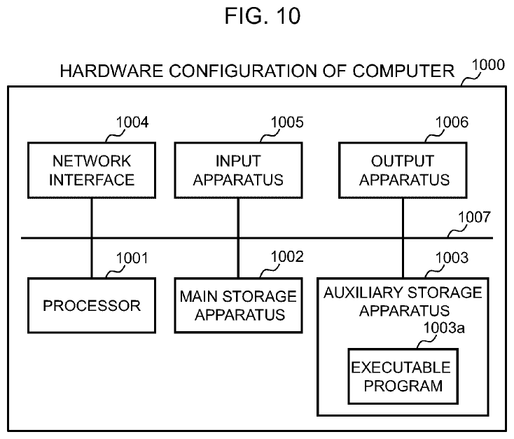

### DESCRIPTION OF EMBODIMENTS

Embodiments of the present invention are explained in detail below with reference to the drawings. Note that the following description and the drawings are exemplification for explaining the present invention and are omitted and simplified as appropriate for clarification of the explanation. Not all of combinations of characteristics explained in the embodiments are essential for solution of the present invention. The present invention is not limited to the embodiments. All applications matching the idea of the present invention are included in the technical scope of the present invention. Those skilled in the art can make various additions, changes, and the like within the scope of the present invention. The present invention can also be carried out in other various aspects. Components may be either plural or singular unless specifically noted otherwise.

In the following explanation, a “CPU (Central Processing Unit)” is an example of one or more processor devices. At least one processor device is typically not limited to the CPU and may be a processor device of another type such as a GPU (Graphics Processing Unit). At least one processor device may be a single core or may be a multicore. At least one processor device may be a processor core.

At least one processor device may be a circuit that is an aggregate of gate arrays described by a hardware description language that performs a part or all of processing. The circuit is a processor device in a broad sense such as an FPGA (Field-Programmable Gate Array), a CPLD (Complex Programmable Logic Device), or an ASIC (Application Specific Integrated Circuit).

In the following explanation, a program is executed by the CPU to implement a processing function called “XXX unit” and becomes an execution entity of processing. The processing function may be implemented by one or more computer programs being executed by a processor, may be implemented by one or more hardware circuits (for example, FPGAS or ASICs), or may be implemented by a combination of the one or more computer programs and the one or more hardware circuits.

When a function is implemented by a program being executed by a processor, decided processing is performed using a storage apparatus and/or an interface apparatus or the like as appropriate. Therefore, the function may be regarded as at least a part of the processor. Processing explained with a functional unit as a subject may be processing performed by a processor or an apparatus including the processor.

The program may be installed from a program source. The program source may be, for example, a recording medium (for example, a non-transitory recording medium) readable by a program distribution computer or a computer. Explanation of functions is an example. A plurality of functions may be collected as one function or one function may be divided into a plurality of functions.

In the following explanation, various kinds of information are sometimes explained in a table format. “YYY table” can be called “YYY information”. A data format of information may be a format (for example, a CSV (Comma Separated Values) format) other than the table format. The various kinds of information may be stored in a storage unit as a table or may be embedded in a program as a logic.

In the following explanation, when elements of the same type are explained without being distinguished, common signs of reference signs are sometimes used and, when the elements of the same type are distinguished and explained, the reference signs are sometimes used.

### First Embodiment

The first embodiment is premised on an environment (for example, a system test environment) in which output periods of logs of subsystems responding to different requests do not overlap, that is, output timings of the logs of the subsystems responding to the requests can be controlled.

In the first embodiment, logs relating to requests of the same type are grouped from output timings of logs and logs of an API gateway. A correlation degree of key items of identifiers (hereinafter referred to as “identifier keys”) relating to requests of different types from a relationship among item values of identifiers (hereinafter referred to as “identifier values”) in groups. The identifier keys are clustered based on the correlation degree among the identifier keys and a related identifier graph serving as information concerning the identifier keys that should be focused when the logs are analyzed.

### Configuration of an Overall System S Including a Log Extraction System 1 According to the First Embodiment

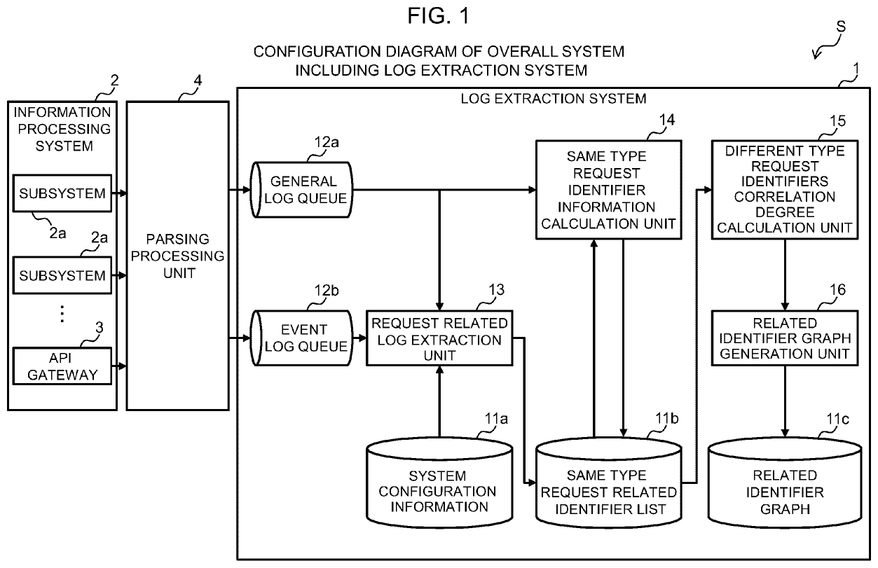

FIG. 1 is a diagram illustrating a configuration of an overall system S including a log extraction system 1 according to the first embodiment. The overall system S includes a log extraction system 1, an information processing system 2, and a parsing processing unit 4. The information processing system 2 includes a plurality of subsystems 2a and an API (Application Programing Interface) gateway 3. The overall system S includes a terminal (not illustrated) used when a user operates the log extraction system 1, the subsystems 2a, the API gateway 3, and the parsing processing unit 4.

The plurality of subsystems 2a configuring the information processing system 2 are, for example, microservices, DB (Data Base) servers, and the like operating in each of a plurality of containers. The respective subsystems 2a output logs according to execution of processing. The API gateway 3 issues an instruction to the subsystems 2a in response to a request from the user, and receives notifications of processing completion of the request from the subsystems 2a. The API gateway 3 outputs an event log including reception time point and response time point of the request.

The parsing processing unit 4 parses general logs output from the subsystems 2a and the event log output from the API gateway 3. The parsing processing unit 4 parses the general logs and the event log to remove variable portions in which variable substitute values are substituted in variables in the logs.

The log extraction system 1 includes system configuration information 11a, a same type request related identifier list 11b, a related identifier graph 11c, a general log queue 12a, and an event log queue 12b. The log extraction system 1 includes a request related log extraction unit 13, a same type request identifier information calculation unit 14, a different type request identifiers correlation degree calculation unit 15, and a related identifier graph generation unit 16.

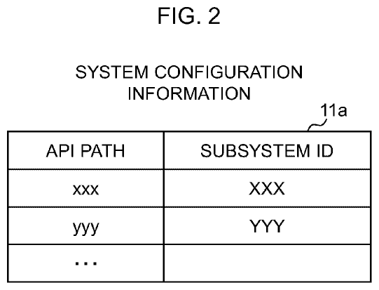

The system configuration information 11a includes, as illustrated in FIG. 2, rows of an “API path” and a “subsystem ID”. The “API path” indicates a path storing an API that receives a request from the user and outputs the request to the subsystem 2a identified by the “subsystem ID”. The system configuration information 11a manages a correspondence relation between information capable of identifying a type of the request and information capable of identifying the subsystem 2a. The system configuration information 11a is stored in, for example, a system configuration information storage unit.

Referring back to FIG. 1, the general log queue 12a is a queue configured on a storage apparatus such as a memory and is an example of a log storing unit that stores the general logs output from the subsystem 2a and parsed by the parsing processing unit 4. The event log queue 12b is a queue configured on the storage apparatus such as the memory and is an example of an event log storing unit that stores an event log output from the API gateway 3 and parsed by the parsing processing unit 4.

The request related log extraction unit 13 reads general logs from the general log queue 12a, reads an event log from the event log queue 12b, and grasps general logs relating to requests of the same type based on the system configuration information 11a and the event log.

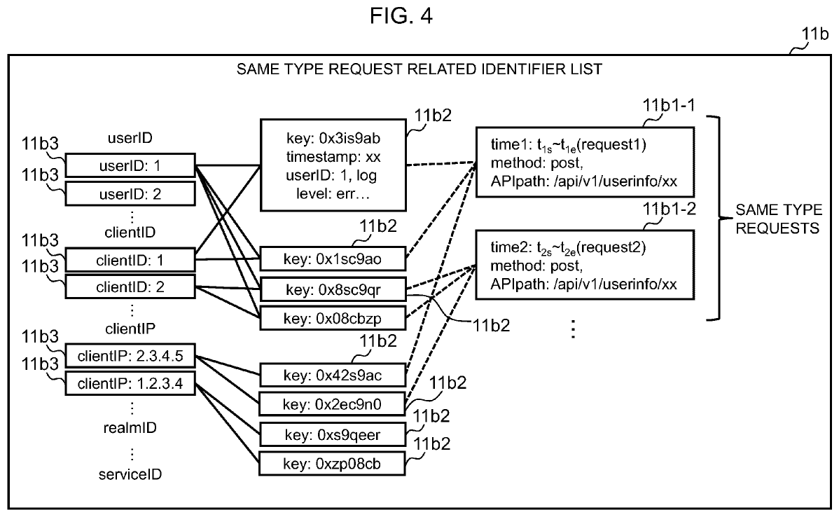

The same type request identifier information calculation unit 14 performs the following processing based on the general logs relating to the requests of the same type grasped by the request related log extraction unit 13. That is, the same type request identifier information calculation unit 14 generates the same type request related identifier list 11b (FIG. 4) for managing a correspondence relation between identifier keys for identifying identifiers used in the information processing system 2 included in the general logs and identifier values representing values that the identifiers take in the general logs.

The different type request identifiers correlation degree calculation unit 15 calculates a correlation degree of identifiers among requests of different types based on identifier values of the same identifiers associated with the requests of the different types in the same type request related identifier list 11b. Link metrics (a distance) is a correlation degree among the identifiers.

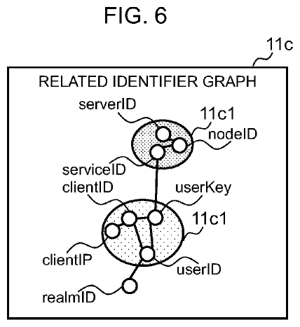

The related identifier graph generation unit 16 sets identifiers as nodes, sets a relation between the identifiers as a link, and sets a correlation degree as link metrics and generates the related identifier graph 11c (FIG. 6) obtained by grouping identifier keys based on the link metrics. In the present embodiment, as a method of the grouping, clustering such as a K-means method is used.

### Related Identifier Extraction Processing According to the First Embodiment

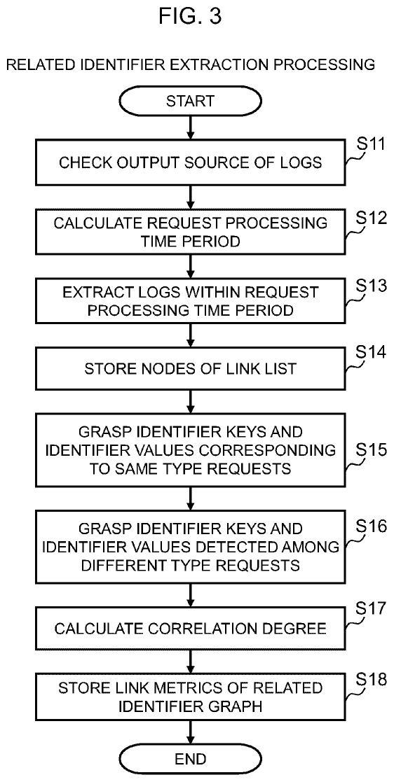

FIG. 3 is a flowchart illustrating related identifier extraction processing according to the first embodiment.

First, in step S11, the request related log extraction unit 13 grasps components (the subsystems 2a at output sources of general logs) relating to APIs from the system configuration information 11a.

Subsequently, in step S12, the request related log extraction unit 13 sets reception time point of a request in the API gateway 3 as start time point tis and sets response time point of the request as end time point tie from the event log stored in the event log queue 12b. Then, the request related log extraction unit 13 calculates a request processing time period timei=tie−tis for each of requests i. Here, i is a natural number representing an identification number of the request.

Referring to FIG. 4, FIG. 4 is a diagram illustrating a configuration of the same type request related identifier list 11b according to the first embodiment. In an example illustrated in FIG. 4, the request processing time period timei is “time1:t1s to t1e” of a request 11b1-1 and “time2:t2s to t2e” of a request 11b1-2. The request related log extraction unit 13 stores, in the same type request related identifier list 11b, requests 11b1 including the request processing time period timei, a method (a request type), and a path (an API path).

Subsequently, in step S13, the request related log extraction unit 13 associates the general logs extracted from the general log queue 12a with one of the requests 11b1 based on, for example, whether timestamps of the method, the path, and the general logs are included in the request processing time period timei of the request 11b1.

Whether the two requests 11b1 are same type requests is determined based on information capable of specifying a request type such as a method, a path, or a URL. In the example illustrated in FIG. 4, since “method: post” and “path:/api/v1/userinfo/xx” are the same in the requests 11b1-1 and 11b1-2, the requests 11b1-1 and 11b1-2 are determined as the same type requests. When request processing time periods timei relating to the same type requests overlap, association with the general logs in an overlapping time period may not be excluded. On the other hand, when request processing time periods timei relating to different requests overlap, in order to improve accuracy, association with the general logs in an overlapping time period is excluded.

Subsequently, in step S14, the same type request identifier information calculation unit 14 performs processing for storing a node of a link list based on the general log extracted in step S13. Specifically, the same type request identifier information calculation unit 14 calculates hash values of character strings excluding different variable substitute values (timestamps or the like) and identifiers for each individual log from the general logs in step S13. The same type request identifier information calculation unit 14 converts the timestamps of the general logs, in which the character strings are converted into the hash values, into relative time points starting from reception time point of an original request. The same type request identifier information calculation unit 14 stores the general logs, to which relative time points are added, as a node 11b2 of the same type request related identifier list 11b (FIG. 4).

Subsequently, in step S15, the same type request identifier information calculation unit 14 grasps a hash value of the node 11b2, the hash value of which is the same in the requests 11b1-1 and 11b1-2 of the same type, as an identifier key relating to the same type requests and grasps all identifier values corresponding to the identifier key. The same type request identifier information calculation unit 14 stores the grasped identifier values in the same type request related identifier list 11b (FIG. 4) as identifier information 11b3. According to steps S12 to S15, the same type request related identifier list 11b is completed.

Note that, in the example illustrated in FIG. 4, an “identifier” is “userID”, “clientID”, “clientIP”, “realmID”, and “serviced”. An “identifier value” is, in the case of the “userID”, values “1” and “2” taken by the “userID” and is, in the case of the “clientID”, values “1” and “2” taken by the “clientID”. The “identifier value” is, in the case of the “clientIP”, values “1”, “2”, “3”, “4”, and “5” taken by the “clientIP”. An “identifier key” is “key: 0x3is9ab”, “key: 0x1sc9ao”, “key: 0x8sc9qr”, “key: 0x08cbzp”, “key: 0x42s9ac”, “key: 0x2ec9n0”, “key: 0xs9qeer”, and “key: 0xzp08cb”.

Subsequently, in step S16, the different type request identifiers correlation degree calculation unit 15 refers to the same type request related identifier list 11b (FIG. 4) and grasps an identifier key (the node 11b2) and an identifier value (the identifier information 11b3) detected among different type requests.

Subsequently, in step S17, the different type request identifiers correlation degree calculation unit 15 calculates a ratio of a combination pattern of identifier values actually appearing among the different type requests to a combination pattern of all identifier values (the identifier information 11b3) relating to the different type requests grasped in step S16 and stores the ratio as a correlation degree.

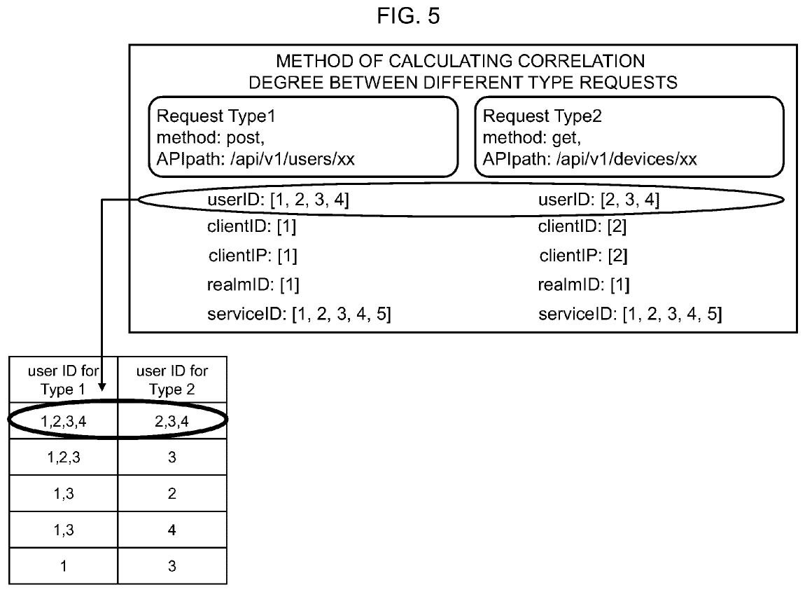

Referring to FIG. 5, step S17 is specifically explained. FIG. 5 is a diagram for explaining a method of calculating a correlation degree between different type requests according to the first embodiment. First, the different type request identifiers correlation degree calculation unit 15 calculates a total number (a first total number) of combinations of total numbers of unique identifier values of the same identifiers observed in general logs for different type requests in general logs in a fixed period in the past. In an example illustrated in FIG. 5, a total number of identifier values of an identifier “userID” for a request of “Type1” is four of “1”, “2”, “3”, and “4” and a total number of identifier values of an identifier “userID” for a request of “Type2” is three of “2”, “3”, and “4”. Therefore, (a first total number) is a total number of Values of the “userID” for the “Type1”×a total number of Values of the “userID” for the “Type2”=4×3=12.

Subsequently, the different type request identifiers correlation degree calculation unit 15 counts a total number (a second total number) of combinations of identifier values of the same identifiers observed by general logs for different type requests. In the example illustrated in FIG. 5, combinations of identifier values of the same identifiers “userID” observed in general logs for different type requests of the “Type1” and the “Type2” are “1, 2, 3, and 4” and “2, 3, and 4”, “1, 2, and 3” and “3”, “1 and 3” and “2”, “1 and 3” and “4”, and “1” and “3”. The second total number is “5”.

Subsequently, the different type request identifiers correlation degree calculation unit 15 calculates a correlation degree (the second total number)/(the first total number). In the example illustrated in FIG. 5, (the second total number)/(the first total number)=5/12.

Subsequently, in step S18, the related identifier graph generation unit 16 sets identifier keys as nodes, sets linking among identifiers as a link, and sets a correlation degree as link metrics. The different type request identifiers correlation degree calculation unit 15 groups the identifier keys based on the link metrics to create the related identifier graph 11c (FIG. 6).

### Effects of the First Embodiment

Effects of the first embodiment are explained with reference to FIG. 6. FIG. 6 is a diagram illustrating a configuration of the related identifier graph 11c according to the first embodiment. The related identifier graph generation unit 16 can see, by grouping simultaneously changing identifiers and identifier keys into the same groups 11c1 as illustrated in FIG. 6, according to a type of a failure that has occurred in the information processing system 2, which identifier should be focused. For example, in the case of a node failure, a large amount of errors occur unevenly in specific “nodeID”, “serviced”, and “serverID”. On the other hand, error logs are detected in various “clientID” and “userID” without being unevenly detected in specific “clientID” and “userID”. In this case, it is possible to perform an effective failure analysis by focusing on the “nodeID”, the “serviced”, and the “serverID” (partitioning with these identifier keys) and analyzing the “nodeID”, the “serviced”, and the “serverID” rather than focusing on and analyzing the “clientID” and the “userID”.

Even in an information processing system in which various identifiers are included in logs and appropriate linking is unknown, liking among the identifiers can be automatically appropriately performed. For example, it is possible to appropriately specify a failure cause and an affected tenant in a cloud environment.

It is possible to dynamically perform partitioning of logs according to an error type.

### Second Embodiment

A second embodiment is not premised on an environment (for example, a system test environment) in which log output timings of the subsystems 2a responding to a request is controllable as in the first embodiment but assumes a reception time of an error log in a real environment.

### Configuration of an Overall System SB Including a Log Extraction System 1B According to the Second Embodiment

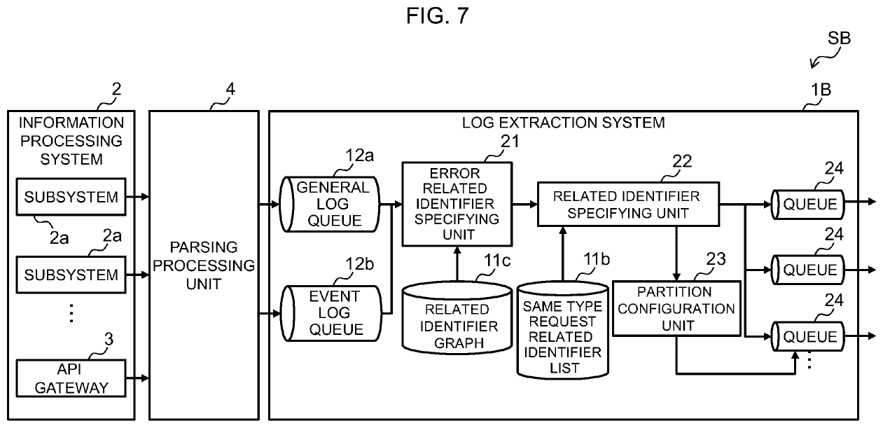

FIG. 7 is a diagram illustrating a configuration of an overall system SB including a log extraction system 1B according to the second embodiment. The log extraction system 1B includes components illustrated in FIG. 7 in addition to or instead of the components of the log extraction system 1 according to the first embodiment. In the log extraction system 1B, the same names and the same reference numerals and signs are given to the same components as the components of the log extraction system 1.

The log extraction system 1B includes the same type request related identifier list 11b, the related identifier graph 11c, the general log queue 12a, the event log queue 12b, an error related identifier specifying unit 21, a related identifier specifying unit 22, a partition configuration unit 23, and one or more queues 24.

When detecting an error from general logs extracted from the general log queue 12a, the error related identifier specifying unit 21 calculates an error distribution for each of identifier values of clusters in the related identifier graph 11c. Specifically, the error related identifier specifying unit 21 refers to the related identifier graph 11c and specifies an identifier in which errors unevenly occur in an identifier value.

The related identifier specifying unit 22 refers to the same type request related identifier list 11b and extracts an identifier key and an identifier value relating to the identifier specified by the error related identifier specifying unit 21. This is because it is highly likely that a failure occurs in a constituent indicated by the identifier specified by the error related identifier specifying unit 21 (a constituent of the information processing system 2 that, for example, is a service if the identifier is “serviceID” and is a node if the identifier is “nodeID”).

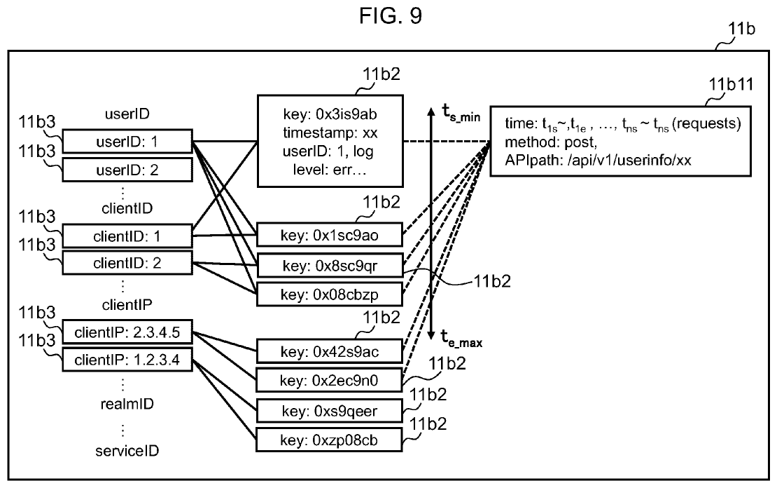

Extraction processing for an identifier key and an identifier value relating to an identifier is explained with reference to FIG. 9. FIG. 9 is a diagram for explaining the extraction processing for an identifier key and an identifier value relating to an identifier according to the second embodiment.

As illustrated in FIG. 9, sets of identifier keys and identifier values corresponding to general logs, timestamps of which are included in first reception time point t1s (ts min) to last response time point tne (te_max) of a request 11b11, among general logs (general logs in which identifier keys are the same) determined, based on the related identifier graph 11c, as the same request as the request 11b11 in which an error has occurred, are extracted as having high possibility of relating to the error. In an example illustrated in FIG. 9, a set of “key: 0x3is9ab” and “userID:1” and “clientID:1”, a set of “key: 0x1sc9ao” and “userID:1” and “clientID:1”, a set of “key: 0x8sc9qr” and “userID:1” and “clientID:2”, and a set of “key: 0x08cbzp” and “userID:1” and “clientID:2” are extracted.

The partition configuration unit 23 generates the queues 24 for each of the identifier keys extracted by the related identifier specifying unit 22. The related identifier specifying unit 22 stores, in the queues 24 for each of the identifier keys generated by the partition configuration unit 23, the general logs extracted from the general log queue 12a by the related identifier specifying unit 22.

Note that the partition configuration unit 23 generates, every time an identifier is specified anew, the queues 24 for each of the identifier keys. When all the general logs are extracted from the generated queues 24 for each of the identifier keys and the queues 24 are emptied, the partition configuration unit 23 deletes the emptied queues 24. When a time to life decided at the time of the generation has elapsed, the partition configuration unit 23 may delete the queues 24. As explained above, the partition configuration unit 23 dynamically configures the queues 24 for each of the identifier keys.

### Related Identifier Extraction Processing According to the Second Embodiment

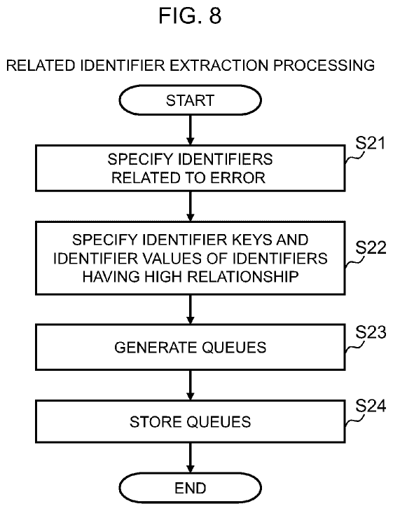

FIG. 8 is a flowchart illustrating related identifier extraction processing according to the second embodiment. The related identifier extraction processing is executed when an error log is received in general logs in a real environment.

First, in step S21, the error related identifier specifying unit 21 specifies identifiers relating to an error. That is, the error related identifier specifying unit 21 refers to the related identifier graph 11c and specifies identifiers in which errors unevenly occur in identifier values. The identifiers specified in step S21 are an example of “specific identifiers”.

Subsequently, in step S22, the related identifier specifying unit 22 specifies identifier keys and identifier values relating to the identifiers specified in step S21 and extracts general logs corresponding to the identifier keys and the identifier values from the general log queue 12a. Subsequently, in step S23, the partition configuration unit 23 generates the queuers 24 for each of the identifier keys specified in step S22.

Subsequently, in step S24, the related identifier specifying unit 22 stores the general logs extracted from the general log queue 12a in the queues 24 for each of the identifier keys generated by the partition configuration unit 23.

### Effects of the Second Embodiment

According to the second embodiment, by analyzing logs stored in queues for each of identifier keys, that is, logs partitioned for each of error types, it is possible to improve efficiency of the log analysis at the time when an error occurs and quickly and accurately specify a cause and an affected range of the error.

By dynamically configuring the queues for each of the identifier keys, it is possible to prevent a storage region storing logs from increasing and compressing resources and promote efficient resource utilization.

### Hardware Configuration of a Computer 1000

FIG. 23 is a diagram illustrating a hardware configuration example of a computer 1000. The computer 1000 executes a predetermined program to thereby implement the units (FIGS. 1 and 7) of the log extraction systems 1 and 1B and the information processing system 2.

The computer 1000 includes a processor 1001 such as a CPU, a main storage apparatus 1002, an auxiliary storage apparatus 1003, a network interface 1004, an input apparatus 1005, and an output apparatus 1006 connected to one another via an internal communication line 1007 such as a bus.

The processor 1001 manages operation control for the entire computer 1000. The main storage apparatus 1002 is configured from, for example, a volatile semiconductor memory and is used as a work memory of the processor 1001. The auxiliary storage apparatus 1003 is configured from a hard disk apparatus, an SSD (Solid State Drive), or a large-capacity nonvolatile storage apparatus such as a flash memory and is used to retain various programs and data for a long period.

An executable program 1003a stored in the auxiliary storage apparatus 1003 is loaded to the main storage apparatus 1002 and executed by the processor 1001 when the computer 1000 is started or when necessary. Accordingly, the log extraction systems 1 and 1B, an input apparatus, an output apparatus, various terminals, and the like are implemented.

Note that the executable program 1003a may be recorded in a non-transitory recording medium, read from the non-transitory recording medium by a medium reading apparatus, and loaded to the main storage apparatus 1002. Alternatively, the executable program 1003a may be acquired from an external computer via a network and loaded to the main storage apparatus 1002.

The auxiliary storage apparatus 1003 stores the executable program 1003a for implementing the log extraction systems 1 and 1B.

The network interface 1004 is an interface apparatus for connecting the computer 1000 to a network in a system or communicating with other computers. The network interface 1004 is configured from an NIC (Network Interface Card) such as a wired LAN (Local Area Network) or a wireless LAN.

The input apparatus 1005 is configured from a keyboard, a pointing device such as a mouse, and the like and is used by the user to input various instructions and information to the computer 1000. The output apparatus 1006 is configured from, for example, a display apparatus such as a liquid crystal display or an organic EL (Electro Luminescent) display and a sound output apparatus such as a speaker and used to present necessary information to the user when necessary.

The embodiments according to the present disclosure are explained in detail above. However, the present disclosure is not limited to the embodiments explained above and can be variously changed without departing from the gist of the present disclosure. For example, the embodiments explained above are explained in detail in order to clearly explain the present invention and are not necessarily limited to embodiments including all the explained components. A part of the components in the embodiments explained above can be added with other components, deleted, and substituted.

A part or all of the components, the functional units, the processing units, and the like explained above may be implemented as hardware by, for example, being designed as an integrated circuit. The components, the functions, and the like explained above may be implemented as software by the processor interpreting and executing programs for implementing the respective functions. Information such as programs, tables, and files for implementing the functions can be stored in a storage apparatus such as a memory, a HDD, or an SDD or a recording medium such as an IC card, an SD card, or a DVD.

In the figures referred to above, control lines and information lines necessary for explanation are illustrated. Not all of control lines and information lines in implementation are necessarily illustrated. For example, almost all the components may be considered to be actually connected to one another.

The processing functions and the data arrangement forms explained above are only examples. The processing functions and the data arrangement forms can be changed to optimum arrangement forms from the viewpoints of performance, processing efficiency, communication efficiency, and the like of hardware and software.

1. A log extraction method executed by a log extraction system that extracts logs output from an information processing system including a plurality of subsystems,
the log extraction system including a processor and a storage unit,
the storage unit including:
an event log storing unit configured to store event logs relating to events generated in the information processing system according to requests to the information processing system;
a log storing unit configured to store the logs output from the plurality of subsystems in response to the events; and
a system configuration information storage unit configured to store system information configuration for managing a correspondence relation between information capable of identifying types of the requests and information capable of identifying the subsystems,
the log extraction method comprising processing for the processor to:
grasp the logs relating to the requests of a same type based on the system configuration information and the event logs;
generate, based on the logs relating to the requests of the same type, a same type request related identifier list for managing a correspondence relation between identifier keys for identifying identifiers used in the information processing system included in the logs and identifier values representing values that the identifiers take in the logs;
calculate correlation degrees of the identifier values among the requests of different types based on the identifier values of the same identifiers associated with the requests of the different types in the same type request related identifier list; and
set the identifier keys as nodes, set a relation between the identifier keys and the identifiers as a link, and set the correlation degrees as link metrics and generate a related identifier graph obtained by grouping the identifier keys based on the link metrics.

2. The log extraction method according to claim 1, further comprising processing for the processor to:
grasp, from the event logs, a processing time period for each of the requests from reception time point when the requests have been received by the information processing system and end time point when processing for the requests by the information processing system has ended;
grasp the logs relating to the requests of the same type based on the system configuration information and timestamps of the logs corresponding to the processing time period;
exclude the identifiers and variable portions from the logs relating to the requests of the same type and calculate hash values of portions remaining after excluding the identifiers and the variable portions from the logs;
set the hash values as the identifier keys and grasp a correspondence relation between the identifier keys and the identifier values;
generate the same type request related identifier list for managing a correspondence relation among the requests of the same type, the identifier keys, and the identifier values;
calculate a first total number obtained by multiplying together numbers of values of identifier values respectively taken by the same identifiers associated with the requests of the different types in the same type request related identifier list;
grasp a second total number that is a total number of patterns of combinations of all the identifier values for the same identifiers associated with the requests of the different types in the same type request related identifier list; and
calculate the correlation degree by dividing the second total number by the first total number.

3. The log extraction method according to claim 1, further comprising processing for the processor to:
refer to the related identifier graph and specify the identifiers relating to the identifier values in the logs acquired from the log storing unit indicating that an error has occurred in the information processing system and set the identifiers as specific identifiers;
refer to the same type request related identifier list and specify a combination of the identifiers based on the specific identifiers and the requests of the same type and the identifier keys and the identifier values corresponding to the identifiers; and
group the logs for each of the identifier keys included in the specified combination of the identifier keys and the identifier values.

4. The log extraction method according to claim 3, further comprising processing for the processor to store, in queues for each of the identifier keys, the logs grouped for each of the identifier keys.

5. The log extraction method according to claim 4, further comprising processing for the processor to generate the queues for each of the identifier keys every time the specific identifiers are specified anew.

6. The log extraction method according to claim 5, further comprising processing for the processor to delete the queues when all the logs are extracted from the queues for each of the identifier keys.

7. The log extraction method according to claim 5, further comprising processing for the processor to delete the queues when a time to life of the queues for each of the identifier keys has elapsed.

8. A log extraction system that extracts logs output from an information processing system including a plurality of subsystems,
the log extraction system comprising a processor and a storage unit,
the storage unit including:
an event log storing unit configured to store event logs relating to events generated in the information processing system according to requests to the information processing system;
a log storing unit configured to store the logs output from the plurality of subsystems in response to the events; and
a system configuration information storage unit configured to store system configuration information for managing a correspondence relation between information capable of identifying types of the requests and information capable of identifying the subsystems, wherein
the processor:
grasps the logs relating to the requests of a same type based on the system configuration information and the event logs;
generates, based on the logs relating to the requests of the same type, a same type request related identifier list for managing a correspondence relation between identifier keys for identifying identifiers used in the information processing system included in the logs and identifier values representing values that the identifiers take in the logs;
calculates correlation degrees of the identifier values among the requests of different types based on the identifier values of the same identifiers associated with the requests of the different types in the same type request related identifier list; and
sets the identifier keys as nodes, sets a relation between the identifier keys and the identifiers as a link, and sets the correlation degrees as link metrics and generates a related identifier graph obtained by grouping the identifier keys based on the link metrics.

9. The log extraction system according to claim 8, wherein the processor further:
grasps, from the event logs, a processing time period for each of the requests from reception time point when the requests have been received by the information processing system and end time point when processing for the requests by the information processing system has ended;
grasps the logs relating to the requests of the same type based on the system configuration information and timestamps of the logs corresponding to the processing time period;
excludes the identifiers and variable portions from the logs relating to the requests of the same type and calculates hash values of portions remaining after excluding the identifiers and the variable portions from the logs;
sets the hash values as the identifier keys and grasps a correspondence relation between the identifier keys and the identifier values;
generates the same type request related identifier list for managing a correspondence relation among the requests of the same type, the identifier keys, and the identifier values;
calculates a first total number obtained by multiplying together numbers of values of identifier values respectively taken by the same identifiers associated with the requests of the different types in the same type request related identifier list;
grasps a second total number that is a total number of patterns of combinations of all the identifier values for the same identifiers associated with the requests of the different types in the same type request related identifier list; and
calculates the correlation degree by dividing the second total number by the first total number.

10. The log extraction system according to claim 8, wherein the processor further:
refers to the related identifier graph and specifies the identifiers relating to the identifier values in the logs acquired from the log storing unit indicating that an error has occurred in the information processing system and sets the identifiers as specific identifiers;
refers to the same type request related identifier list and specifies a combination of the identifiers based on the specific identifiers and the requests of the same type and the identifier keys and the identifier values corresponding to the identifiers; and
groups the logs for each of the identifier keys included in the specified combination of the identifier keys and the identifier values.

11. The log extraction system according to claim 10, wherein the processor further stores, in queues for each of the identifier keys, the logs grouped for each of the identifier keys.

12. The log extraction system according to claim 11, wherein the processor further generates the queues for each of the identifier keys every time the specific identifiers are specified anew.

13. The log extraction system according to claim 12, wherein the processor further deletes the queues when all the logs are extracted from the queues for each of the identifier keys.

14. The log extraction system according to claim 12, wherein the processor further deletes the queues when a time to life of the queues for each of the identifier keys has elapsed.
